(19) United States
(12) Patent Application Publication
(10) Pub. No.: US 2011/0277012 A1
(43) Pub. Date: Nov. 10, 2011

(54) SYSTEM FOR AUGMENTING ACCESS TO RESOURCES

(75) Inventors: Bernadette A. Carter, Raleigh, NC (US); Al Chakra, Apex, NC (US); Christopher A. Hambridge, Raleigh, NC (US); Oriana J. Love, Austin, TX (US)

(73) Assignee: INTERNATIONAL BUSINESS MACHINES CORPORATION, Armonk, NY (US)

(21) Appl. No.: 12/775,520

(22) Filed: May 7, 2010

(51) Int. Cl. H04L 29/06; G06F 11/30

(52) U.S. Cl. 726/1; 726/5

(57) ABSTRACT

The different illustrative embodiments provide a method, data processing system, and computer program product for managing access to resources. A number of access permissions of a first user to a number of resources in a computer system are provided to a second user in response to a presentation of first credentials for the first user to the computer system. A level of presence of the first user relative to the computer system and/or the second user is monitored. The number of access permissions of the first user to the number of resources in the computer system continues to be provided to the second user as long as a preselected level of presence of the first user is present.

### BACKGROUND

1. Field

The disclosure relates generally to data processing systems and, in particular, to a method and apparatus for processing data. Still more particularly, the present disclosure relates to a method and apparatus for managing access to resources.

2. Description of the Related Art

Network data processing systems provide resources that are accessed by different users. These resources may take a number of different forms including, for example, hardware, software, and a combination of hardware and software. For example, users may access documents, databases, spreadsheets, images, video, programs, printers, server processes, routers, and/or other resources in a network data processing system.

Some users often have different access levels as compared to other users. The access to resources is often controlled through various permissions assigned to the different users. These permissions may be implemented using mechanisms, such as access control lists. An access control list is a list of permissions attached to a resource. An access control list specifies which users or system processes are allowed to access a resource. Additionally, an access control list specifies what operations are allowed to be performed on a resource.

Different users are provided different types of access to resources based on a number of different factors. For example, a newer employee may be granted limited access to a resource, while a more experienced employee may be granted additional access to a particular resource. For example, if the employee is a software engineer in training, the software engineer may not receive as many permissions to resources as compared to a more experienced software engineer. This less-experienced software engineer is a trainee and receives training on software systems before receiving any additional permissions.

With this type of training, the trainee may review certain parts of a code base under the supervision of a trainer. The trainee is eventually asked to update the code base but currently only has read-only access. The trainer may be an experienced software engineer with knowledge about code bases. The trainee has not been given access to change the code base, because the software engineer has not yet received the training for this type of updating. The trainer may train the trainee physically at a computer with the trainee or through an e-meeting.

During the training, the trainee is provided an opportunity to update the code base under the supervision of the trainer. Currently, the trainer logs in using the trainer's credentials to obtain access to write to the code base. Then the trainee performs the updates under the supervision of the trainer. In this manner, the trainee is able to learn about coding conventions and make the needed changes to update the code base.

### SUMMARY

The different illustrative embodiments provide a method, data processing system, and computer program product for managing access to resources. A number of access permissions of a first user to a number of resources in a computer system are provided to a second user in response to a presentation of first credentials for the first user to the computer system. A level of presence of the first user relative to the computer system is monitored. The number of access permissions of the first user to the number of resources in the computer system continues to be provided to the second user as long as a preselected level of presence of the first user is present.

### BRIEF DESCRIPTION OF THE SEVERAL VIEWS OF THE DRAWINGS

FIG. 1 is an illustrative diagram of a data processing environment in which illustrative embodiments may be implemented;

FIG. 2 is an illustration of a data processing system in accordance with an illustrative embodiment;

FIG. 3 is an illustration of a block diagram of a resource management environment in accordance with an illustrative embodiment;

FIG. 4 is an illustration of a monitoring system in accordance with an illustrative embodiment;

FIG. 5 is an illustration of a diagram of a policy in accordance with an illustrative embodiment;

FIG. 6 is an illustration of a resource management environment in accordance with an illustrative embodiment;

FIG. 7 is an illustration of a resource management environment in accordance with an illustrative embodiment;

FIG. 8 is an illustration of a flowchart of a process for managing resources in a network in accordance with an illustrative embodiment;

FIG. 9 is an illustration of a flowchart of a process for ceasing to provide a user permission to access resources in accordance with an illustrative embodiment; and

FIG. 10 is an illustration of a flowchart of a process for managing access to resources in accordance with an illustrative embodiment.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the data processing system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

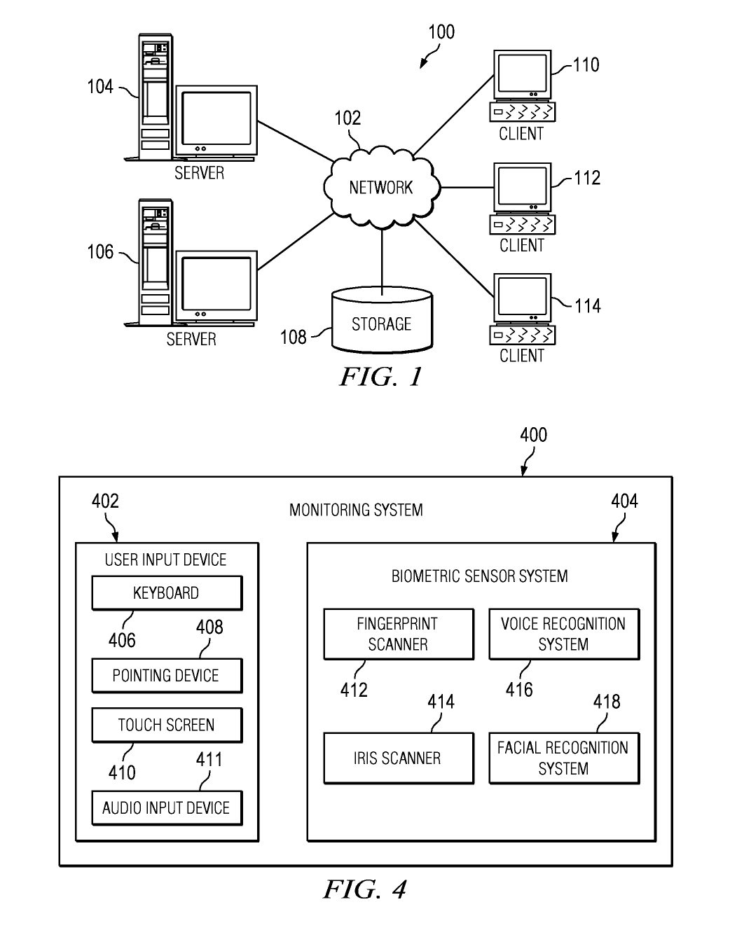

With reference now to the figures and in particular with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Different users of the computers of network data processing system 100 may have different permissions to access various resources within network data processing system 100. Processes and apparatus to control permissions for users may be implemented in network data processing system 100 in accordance with an illustrative embodiment.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

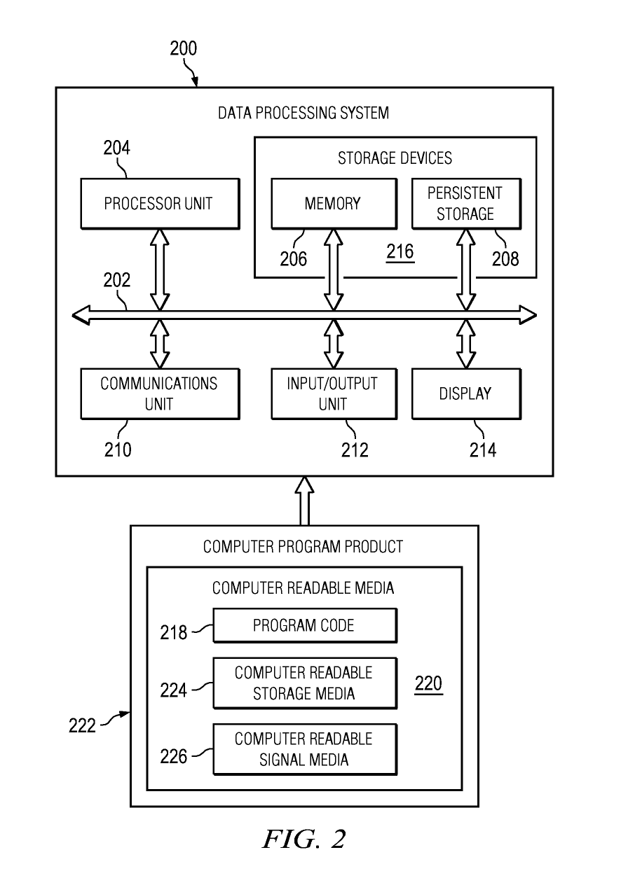

Turning now to FIG. 2, an illustration of a data processing system is depicted in accordance with an illustrative embodiment. Data processing system 200 is an example of a data processing system that may be used to implement different computers in network data processing system 100 in FIG. 1. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a number of processors, a multi-processor core, or some other type of processor, depending on the particular implementation. A number, as used herein with reference to an item, means one or more items. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms, depending on the particular implementation.

For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for running by processor unit 204. The processes of the different embodiments may be performed by processor unit 204 using computer implemented instructions, which may be located in a memory, such as memory 206.

These instructions are referred to as program code, computer usable program code, or computer readable program code that may be read and run by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto or transferred to data processing system 200 for running by processor unit 204. Program code 218 and computer readable media 220 form computer program product 222 in these examples. In one example, computer readable media 220 may be computer readable storage media 224 or computer readable signal media 226. Computer readable storage media 224 may include, for example, an optical or magnetic disk that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory, that is connected to data processing system 200. In some instances, computer readable storage media 224 may not be removable from data processing system 200. In these illustrative examples, computer readable storage media 224 is a non-transitory computer readable storage medium.

Alternatively, program code 218 may be transferred to data processing system 200 using computer readable signal media 226, Computer readable signal media 226 may be, for example, a propagated data signal containing program code 218. For example, computer readable signal media 226 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor. As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206, or a cache such as found in an interface and memory controller hub that may be present in communications fabric 202.

The illustrative embodiments recognize and take into account a number of different considerations. For example, the illustrative embodiments recognize and take into account that having a trainer log in with the trainer's credentials to obtain access to a resource for use by a trainee for training may leave a security gap in the management of resources. An example of one situation in which a security gap may occur is if the trainer forgets to log out and leaves the trainee at the computer. With this situation, a potential exists for the trainee to make changes to a resource that may cause undesired effects on the resource if the trainee accesses the resource without the experience or training needed. For example, if the trainee performs additional updates for the code base without supervision, the trainee may make mistakes due to the lack of experience and needed training. The result may be that the code base no longer functions or performs desired operations when run on a computer.

The different illustrative embodiments also recognize that in some cases the trainer may be present, but the trainer's attention may be taken away from the training process. For example, the trainer may receive an email, a telephone call, or some other event may occur that may decrease the level of engagement of the trainer in the training session. The different illustrative embodiments recognize that the trainer has to remember to revoke the access provided to the trainee while taking care of another situation.

The different illustrative embodiments recognize and take into account that these and other situations make it undesirable to have trainers sharing their access credentials, such as user ids and passwords, with trainees. The illustrative embodiments recognize and take into account that it is desirable to have each user, including the trainee, log in with their own user identification and password.

Thus, the different illustrative embodiments provide a method and apparatus for managing access to resources. In response to a presentation of first credentials for a first user to a computer system, a second user is provided a number of access permissions of the first user to resources in the computer system. A level of presence of the first user relative to the computer system is monitored. The second user continues to be provided access to the number of permissions of the first user to the resources in the computer system as long as a preselected level of presence of the first user is present. The presence of the first user may be at least one of physical proximity, logical proximity, and a level of communication relative to the computer system.

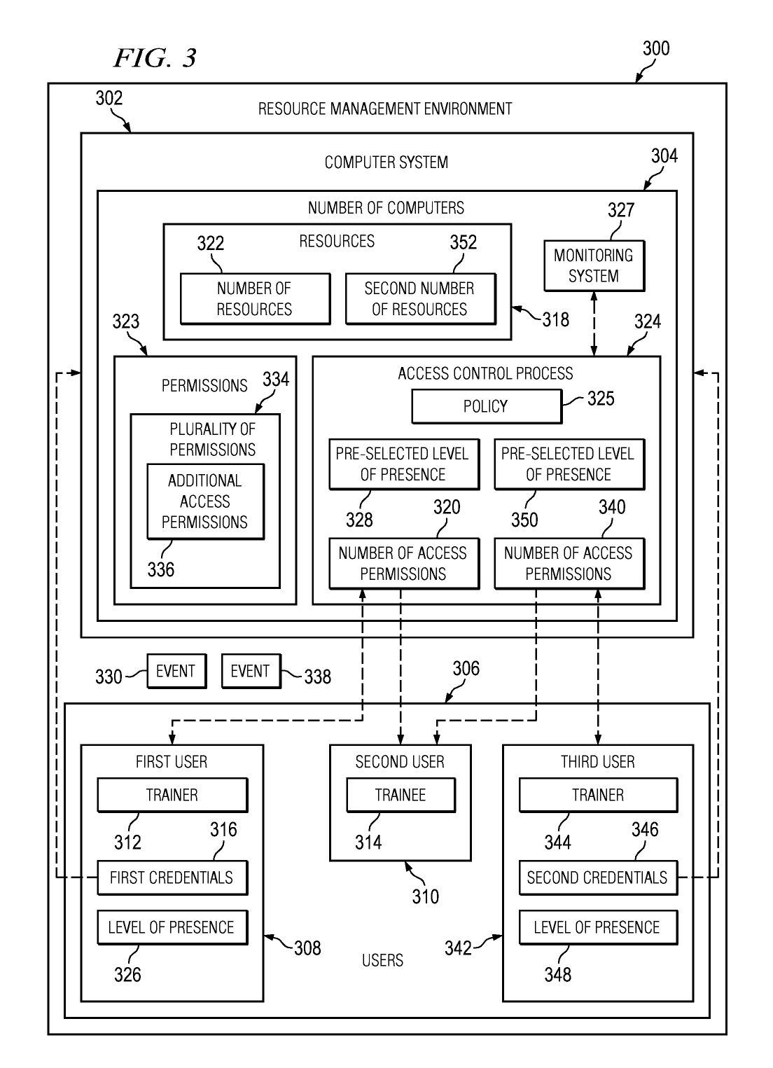

With reference now to FIG. 3, a block diagram of a resource management environment is depicted in accordance with an illustrative embodiment. Network data processing system 100 in FIG. 1 is an example of hardware that may be used in resource management environment 300.

In this illustrative example, resource management environment 300 includes computer system 302. Computer system 302 is comprised of number of computers 304. A number, as used herein with reference to items, means one or more items. For example, a number of computers is one or more computers. Computer system 302 may be, for example, network data processing system 100, data processing system 200, or some other combination of hardware in which processor units and computers are present.

As depicted, users 306 perform operations at computer system 302. In these examples, users 306 include first user 308 and second user 310. In this example, first user 308 is trainer 312, and second user 310 is trainee 314.

First user 308 presents first credentials 316 to computer system 302. First credentials 316 verify the identity of first user 308. In these examples, credentials are information used to control access to resources 318 in computer system 302. These credentials may take a number of different forms. For example, first credentials 316 may be at least one of a password and user identifier, a certificate, a biometric input, and some other suitable form of credential.

As used herein, the phrase “at least one of”, when used with a list of items, means that different combinations of one or more of the listed items may be used and only one of each item in the list may be needed. For example, “at least one of item A, item B, and item C” may include, for example, without limitation, item A or item A and item B. This example also may include item A, item B, and item C, or item B and item C.

In response to the presentation of first credentials 316 for first user 308 to computer system 302, second user 310 is provided with number of access permissions 320 of first user 308 to number of resources 322 in resources 318. Number of access permissions 320 allows first user 308 access to number of resources 322. In this illustrative example, this access is controlled using access control process 324 which runs on computer system 302.

Second user 310 may have number of access permissions 320 to number of resources 322. Number of access permissions 320 may be a particular number of access permissions provided for a user in training. Number of access permissions 320 may be in the form of an access control list for second user 310. In one illustrative example, access control process 324 may add number of access permissions 320 of first user 308 to number of access permissions in the access control list for second user 310. This access control list allows second user 310 to access number of resources 322.

In another example, access control process 324 may generate a second access control list containing number of access permissions 320 for second user 310. This second access control list may take the place of the access control list containing number of access permissions 320 to provide second user 310 with access to number of resources 322. For example, the second access control list may be used when second user 310 is in training with first user 308.

Number of resources 322 may take a number of different forms. For example, number of resources 322 may be at least one of an application, code, an executable file, a dynamic link library, a word processing file, an image, a spreadsheet, a server process, a router, a switch, a computer within computer system 302, an access point, a proxy server, and other suitable resources.

In these illustrative examples, access control process 324 selects number of access permissions 320 from permissions 323 for first user 308. Number of access permissions 320 is selected using policy 325 in these illustrative examples. Policy 325 is a number of rules used by access control process 324 in controlling access to resources 318.

Access control process 324 monitors level of presence 326 of first user 308 relative to computer system 302. In these examples, the monitoring is performed using monitoring system 327. Access control process 324 continues to provide second user 310 number of access permissions 320 as long as preselected level of presence 328 for first user 308 is present.

If level of presence 326 of first user 308 is not at or greater than preselected level of presence 328, access control process 324 ceases to provide second user 310 number of access permissions 320. Additionally, access control process 324 also may cease to provide second user 310 number of access permissions 320 for first user 308 in response to event 330 using policy 325, even though preselected level of presence 328 for first user 308 is present.

Policy 325 is used by access control process 324 to determine when event 330 should cause access control process 324 to cease to provide number of access permissions 320 for first user 308 to second user 310. This ceasing to provide number of access permissions 320 may also be referred to as a revocation of number of access permissions 320. In some illustrative examples, policy 325 may indicate a period of time during which number of access permissions 320 are provided to second user 310. In other illustrative examples, policy 325 may also indicate which access permissions in permissions 323 to select as number of access permissions 320 for first user 308 to provide to second user 310.

In these illustrative examples, event 330 may take a number of different forms. For example, event 330 may be selected from an attempt to access a selected file, an input to delete a particular file, a movement of an application from a foreground to a background state, second user 310 no longer sharing a screen in an electronic meeting, or some other suitable event.

Level of presence 326 may take a number of different forms. For example, level of presence 326 may be selected from at least one of a physical proximity, a collaboration proximity, a level of actions performed by first user 308, a type of action, a presence of first user 308 with second user 310 in an electronic conference, a presence of first user 308 and second user 310 at a computer in computer system 302, communication between first user 308 and second user 310, first user 308 communicating with second user 310 over a telephone, and other suitable types of presence for first user 308 that can be measured. A physical proximity of a user may be, for example, a presence of a user at a computer, and/or the distance of a user with respect to a computer. A collaboration proximity of a user may be, for example, a presence of a user in a web conference, over a telephone, in a chat session, and/or having some other communication or interaction between first user 308 and second user 310. The presence of a user may be determined by a frequency of instant messages, a frequency of responses during a phone conversation, a level of interaction in a web conference or chat session, or some other suitable factor.

In some illustrative examples, number of access permissions 320 is only a portion of plurality of access permissions 334 for first user 308. In some illustrative examples, second user 310 may be provided with additional permissions 336 from plurality of access permissions 334. For example, additional access permissions 336 from plurality of access permissions 334 may be provided to second user 310 in response to event 338. Event 338 may be an event that occurs during a training session. For example, event 338 may be one of a completion of a portion of a training section, a selected access on number of resources 322 made by first user 308, a selected access on number of resources 322 made by second user 310, a user input from first user 308, or some other suitable type of event.

Additionally, second user 310 also may be provided number of access permissions 340 from third user 342. In this example, third user 342 is trainer 344. Number of access permissions 340 may be different or have some overlap with number of access permissions 320. Second user 310 is provided with number of access permissions 340 for third user 342 in response to presentation of second credentials 346 for third user 342 to computer system 302.

In a similar fashion, access control process 324 may monitor level of presence 348 for third user 342. Number of access permissions 340 may continue to be provided to second user 310 as long as preselected level of presence 350 for third user 342 is present. Preselected level of presence 350 may be different from preselected level of presence 328, depending on the particular implementation. Additionally, second number of resources 352 may be the same as number of resources 322. Of course, other numbers of users that function as trainers also may be present in addition to first user 308 and third user 342. These other users also may provide additional numbers of permissions to second user 310.

The illustration of resource management environment 300 in FIG. 3 is not meant to imply physical or architectural limitations to the manner in which different illustrative embodiments may be implemented. Other components in addition and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, in other illustrative embodiments, additional users, in addition to second user 310, who are also trainees, may be present. These additional users also may be provided number of access permissions 320 and/or number of access permissions 340 in the same manner as second user 310.

In yet other illustrative embodiments, level of presence 326 for first user 308 may be different types of levels of presence. For example, first user 308 may be physically present with respect to a computer system and second user 310. When another trainee is present, first user 308 may work with that trainee at the same time as second user 310 through a teleconference. The amount of interaction of first user 308 with the teleconference may be used to measure level of presence 326 of first user 308.

In still other illustrative embodiments, the relationship between first user 308 and second user 310 may be some suitable relationship other than between a trainer and a trainee. For example, without limitation, first user 308 may be an administrator and second user 310 may be a user. In some examples, first user 308 may be a manger and second user 310 may be an employee. In other examples, first user 308 may be a member of an organization and second user 310 may be a guest of the organization. In still other examples, first user 308 may be a security officer with a high level of security clearance as compared to second user 310, who may be a security officer with a low level of security clearance as compared to first user 308. In some illustrative embodiments, first user 308 may be a team leader and second user 310 may be a team member.

In other illustrative embodiments, first user 308 and second user 310 may be provided number of access permissions 320 only when first user 308 and second user 310 both have level of presence 326. In other words, first user 308 and second user 310 may only be provided access to number of resources 322 when both first user 308 and second user 310 both have level of presence 326.

With reference now to FIG. 4, an illustration of a monitoring system is depicted in accordance with an illustrative embodiment. In this example, monitoring system 400 is an example of one implementation for monitoring system 327 in FIG. 3. The different devices illustrated in FIG. 4 may be used to detect a level of presence of a user. In particular, these devices may be used to detect a level of presence of a user in the form of a physical proximity of a user and/or a level of actions performed by a user.

In this illustrative example, monitoring system 400 may include at least one of user input devices 402 and biometric sensor system 404. User input devices 402 may include at least one of keyboard 406, pointing device 408, touch screen 410, audio input device 411, and other suitable devices for receiving user input. Keyboard 406 may detect keystrokes entered by a user. Pointing device 408 detects movement of a pointer made by a user as well as movement of objects that may be selected using pointing device 408. Touch screen 410 may receive user input from a finger or a stylus manipulated by a user. Audio input device 411 may be, for example, a microphone that detects sound. These different devices may be used to detect the level of presence of a user, such as level of presence 326 of first user 308 in resource management environment 300 in FIG. 3.

The amount of activity extracted from user input devices 402 may be used to provide some level of presence. For example, a number of keystrokes made using keyboard 406 may be used to determine an amount of activity of a user. This amount of activity may be used to identify the level of presence of the user.

The level of presence of a user also may be detected through biometric sensor system 404. Biometric sensor system 404 may include at least one of fingerprint scanner 412, iris scanner 414, voice recognition system 416, facial recognition system 418, and other suitable components. Fingerprint scanner 412 may be used to detect whether a particular user is located at a computer. Fingerprint scanner 412 may be used to detect the level of presence of a user based on the user's access to a computer. Iris scanner 414 may be used in a similar fashion to detect whether a particular user is present at a computer.

Voice recognition system 416 and/or facial recognition system 418 may be able to detect the presence of a user at a computer. Further, these two systems also may be used to detect the amount of interaction or use of the computer by the user as well as the physical proximity of the user with respect to the computer.

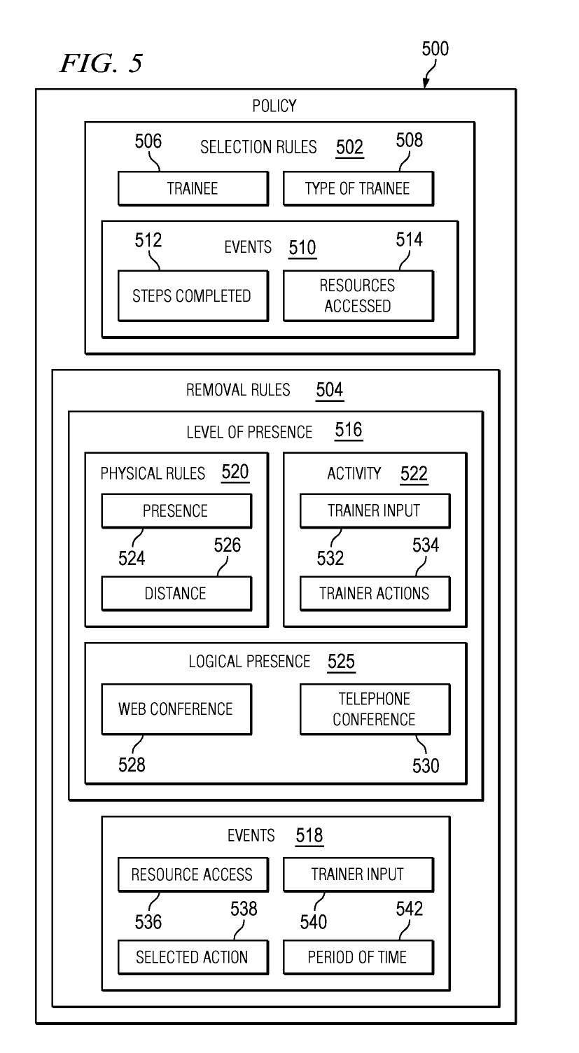

With reference now to FIG. 5, a diagram of a policy is depicted in accordance with an illustrative embodiment. Policy 500 is an example of one implementation for policy 325 in FIG. 3.

As depicted, policy 500 includes selection rules 502 and removal rules 504. Selection rules 502 are used to select the number of permissions of the trainer given to the trainee. Removal rules 504 are rules used to remove the number of permissions of the trainer given to the trainee.

In these illustrative examples, selection rules 502 include at least one of trainee 506, type of trainee 508, and events 510. Trainee 506 is a rule that identifies a number of permissions for a particular trainee. Each trainee may be assigned a number of permissions for each trainer that may work with the trainee. This number of permissions may be assigned based on the relationship between the trainer and the trainee. For example, the number of permissions for the trainer may be assigned to the trainee based on the position of the trainer and the trainee in a social network or organizational network.

Type of trainee 508 is a rule that identifies a number of permissions assigned to a trainee based on the class or title of a trainee. For example, a software engineer in training may be assigned a different number of permissions of a trainer as compared to an IT person in training.

Events 510 are rules for selecting number of permissions for a trainee based on events that may occur. For example, events 510 may include steps completed 512 and resources accessed 514. Steps completed 512 are rules that assign or provide the trainee additional permissions of the trainer as different steps in a training session are completed. For example, with a successful completion of changes to a code base, a software engineer in training may be provided additional permissions to run the code base. Resources accessed 514 may include rules that provide the trainee additional permissions based on the resources being used. As one illustrative example, a rule may indicate that a trainee may not have access to edit particular files until other files have been edited.

Removal rules 504 are rules used to remove permissions from the trainee. For example, removal rules 504 includes level of presence 516 and events 518. Level of presence 516 includes rules that identify when permission should be removed from a trainee based on a level of presence of a trainer. For example, level of presence 516 may include physical rules 520, logical presence 525, and activity 522.

For example, physical rules 520 include presence 524 and distance 526. Presence 524 includes rules that indicate that a physical presence of the trainer at the computer of the trainee is sufficient to maintain providing the number of permissions of the trainer to the trainee. Distance 526 includes rules that indicate a distance from the computer with the trainee at which the trainer must be such that the number of permissions can still be provided. If the trainer moves outside of the distance in the rules in distance 526, the number of permissions is removed or is no longer provided to the trainee.

Logical presence 525 includes rules for the collaboration proximity of the trainer to the trainee. For example, logical presence 525 may be a level of involvement or interaction with a web conference or telephone conference. In this type of example, logical presence 525 may include web conference 528 or telephone conference 530. Web conference 528 may be a rule that the trainer must be on a web conference with the trainee for the number of permissions to be provided to the trainee.

Telephone conference 530, in this example, is a rule stating that a telephone conference must be present between the trainer and the trainee for the number of permissions to continue to be provided to the trainee. If the telephone conference is terminated by the trainer, the trainee, or through some other unexpected event, the number of permissions is no longer provided to the trainee. In some illustrative examples, the number of permissions may no longer be provided to the trainee in response to an absence of conversation during the telephone conference for a selected period of time.

Activity 522 includes trainer input 532 and trainer actions 534. Trainer input 532 includes rules identifying the input that a trainer makes to provide the level of presence needed to continue to provide the number of permissions of the trainer to the trainee. For example, the trainer input may be keystrokes to a keyboard, mouse movement and input, and/or other suitable input. Trainer actions 534 include rules identifying actions of the trainer that indicate whether the trainer is concentrating on the training session or has become distracted.

For example, trainer actions 534 may include detecting that the movement and/or location of the user indicate that the trainer is engaged in the training session. If the trainer picks up a phone and begins a conversation during the training session, these trainer actions may indicate that the level of presence is no longer high enough to provide the number of permissions of the trainer to the trainee.

As another example, if the trainer does not remain facing the computer for some period of time, the level of presence of the trainer may be considered to no longer have a level of presence that provides a number of permissions of the trainer to the trainee.

Events 518 are rules that cause the access control process to no longer provide the number of permissions to the trainee, even though level of presence 516 in removal rules 504 may be met. For example, events 518 include resource access 536, selected action 538, trainer input 540, and period of time 542. Resource access 536 may remove the number of permissions if the trainee attempts to access a particular resource or number of resources that have been identified in the rule. For example, in a training session, a trainee may only be provided the number of permissions to one code base and not another code base. If the trainee attempts to access the second base, the number of permissions is removed.

Selected action 538 includes rules identifying a number of actions on a resource that cause the number of permissions of the trainee to no longer be provided to the trainee. For example, if the trainee attempts to delete a particular file or library, the number of permissions is no longer provided, and the deletion of the particular file or library does not occur. Trainer input 540 may be an input from the trainer to remove the number of permissions from the trainee even though the trainer has met the rules in level of presence 516 needed to provide the number of permissions to the trainee.

Period of time 542 includes rules that identify a period of time after which permissions are no longer provided to a trainee. Period of time 542 may be a period of time entered by the trainer or some other user as to how long the trainee will have the number of permissions of the trainer. For example, the period of time may be selected as being 10 minutes, 30 minutes, one hour, or some other suitable period of time. After this period of time has elapsed, the trainee is no longer provided with the number of permissions of the trainer. This occurs even if the trainer still meets the rules in level of presence 516 in these depicted examples.

The illustration of policy 500 in FIG. 5 is only an example of one manner in which policy 325 in FIG. 3 may be implemented. Other policies may include or have rules other than the rules illustrated in these particular examples. Of course, in some illustrative examples, some of the rules illustrated for policy 500 may be omitted or replaced with other rules.

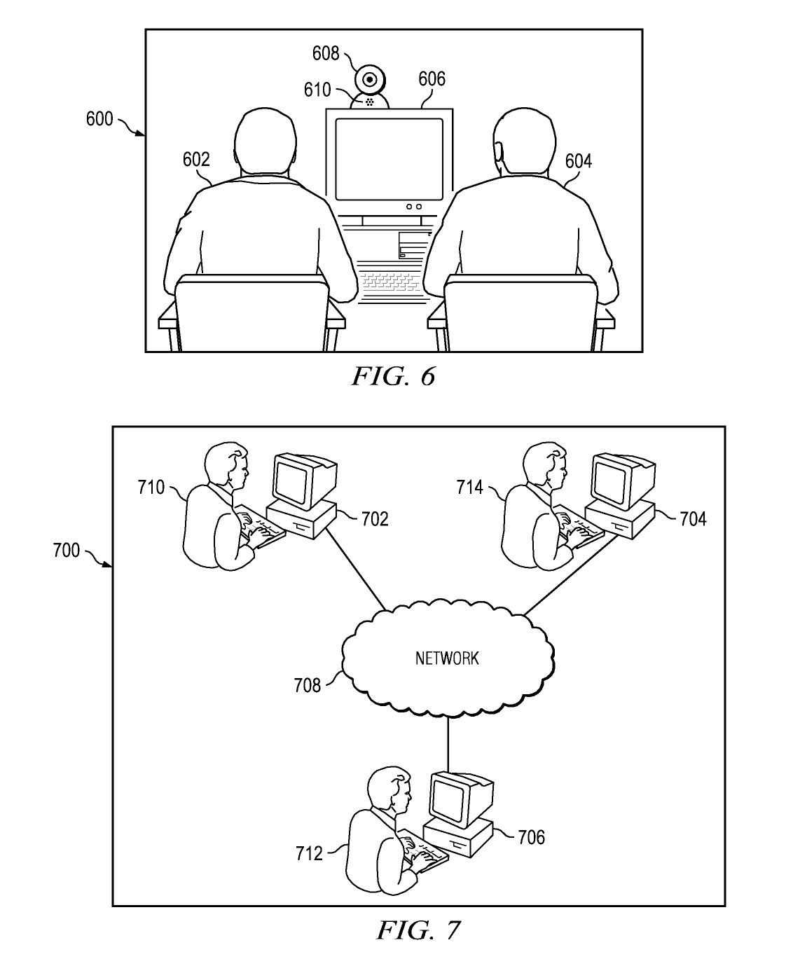

With reference next to FIG. 6, an illustration of a resource management environment is depicted in accordance with an illustrative embodiment. In this example, resource management environment 600 is an example of one implementation for resource management environment 300 in FIG. 3. As depicted, resource management environment 600 includes user 602, user 604, and computer 606. User 602 and user 604 are located at computer 606. Computer 606 is an example of an implementation of computer system 302 in FIG. 3.

User 602 is a trainer, while user 604 is a trainee. User 602 enters credentials into computer 606 to begin a training session in this example. User 604 will have the number of access permissions of user 602 as long as user 602 has a selected level of presence. In this example, the level of presence of user 602 may be determined by the presence of user 602 at computer 606 or physical proximity of user 602 to computer 606.

Camera 608 may be part of facial recognition system 418 in FIG. 4 and identifies the presence of user 602 at computer 606. In these illustrative examples, a presence of user 602 at computer 606 results in the number of permissions being provided to user 604.

Further, camera 608 may be used to determine the physical proximity of user 602 to computer 606. For example, when user 602 is located within a selected distance of computer 606, user 604 is provided with a number of access permissions of user 602.

Camera 608 also includes microphone 610 in this depicted example. Microphone 610 also may be used in voice recognition system 416 in FIG. 4 to detect the presence of user 602 at computer 606.

Additionally, the amount of activity or interaction of user 602 with user 604 may be detected using at least one of camera 608 and microphone 610. As one illustrative example, camera 608 may be used to track a focus of the eyes of user 602 and/or user 604. An absence or presence of the focus of the eyes of a user may determine the amount of activity or interaction of user 602 with user 604.

In another illustrative example, microphone 610 may be used to detect a speech pattern different from the speech pattern related to the tasks being performed by user 602 and user 604. In other examples, microphone 610 may be used to detect the interaction between a user and a cell phone, a music player, or some other device.

If user 602 is distracted by another user, a phone call, or some other event, the level of presence of user 602 may be reduced such that the number of permissions of user 602 may no longer be provided to user 604. When user 602 again has the desired level of presence, user 604 may then again be provided the number of access permissions of user 602.

With reference now to FIG. 7, an illustration of a resource management environment is depicted in accordance with an illustrative embodiment. In this example, resource management environment 700 is an example of one implementation of resource management environment 300 in FIG. 3. In this illustrative example, computer 702, computer 704, and computer 706 are connected to network 708. These components may be an example of an implementation of computer system 302 in FIG. 3. User 710 is a trainee, while user 712 is a trainer. In this example, user 712 performs training of user 710 using an electronic conference over network 708.

Various web conferencing tools may be used for the electronic conference. For example, the web conferencing system may be implemented using Lotus Live Meetings, which is available from International Business Machines Corporation or WebEx, which is available from WebEx Communications, Inc.

In this example, user 712 presents credentials to the computer system. As a result, user 710 has a number of permissions of user 712 in performing the training session in these examples. In the web conference, user 710 may share a desktop with user 712. As long as user 712 maintains a selected level of presence, user 710 has the number of permissions of user 712.

The level of presence of user 712 may be the presence of user 712 in the web conference, the amount of activity performed by user 712 in the web conference, the physical proximity of user 712 to computer 706 during the web conference, and other types of presences. If user 712 logs off or does not have a desired level of activity, the number of permissions of user 712 is no longer provided to user 710.

Additionally, some events may occur, which causes the number of permissions of user 712 to no longer be provided to user 710. For example, if user 710 attempts to perform an action to delete selected files, the providing of the number of permissions of user 712 may be interrupted or suspended. Also, the action attempting to be performed by user 712 is not performed. Additionally, if user 712 moves an application from the front to a background such that the application can no longer be seen on the desktop, the permissions may no longer be provided to user 710.

As another example, if user 710 no longer shares the desktop with user 712, the number of permissions of user 712 also may no longer be provided to user 710. Further, user 710 also may be provided permissions from additional users, such as user 714 at computer 704. User 714 is another trainer in this example.

When user 714 presents credentials, a number of permissions of user 714 are also provided to user 710. These credentials are to various resources. The resources for the number of permissions for user 714 and user 712 may be to the same resources or different resources, depending upon the particular implementation. If user 714 is no longer within a desired level of presence, the number of permissions of user 714 also may be removed. In some illustrative examples, the permissions of user 712 and user 714 may remain even if one of user 712 and user 714 no longer has a desired level of presence.

The illustration of resource management environment 600 in FIG. 6 and resource management environment 700 in FIG. 7 are only examples of implementations of resource management environment 300 in FIG. 3. These examples are not meant to imply physical or architectural limitations to the manner in which other resource environments may be implemented. Other resource management environments may include other numbers of networks in computers other than those illustrated in these depicted examples. For example, in some illustrative examples, computers may be in communication with each other using a peer-to-peer network, a direct wireless communications link, or some other suitable type of communication. Additionally, in some illustrative examples, a single trainer may be present to train multiple users.

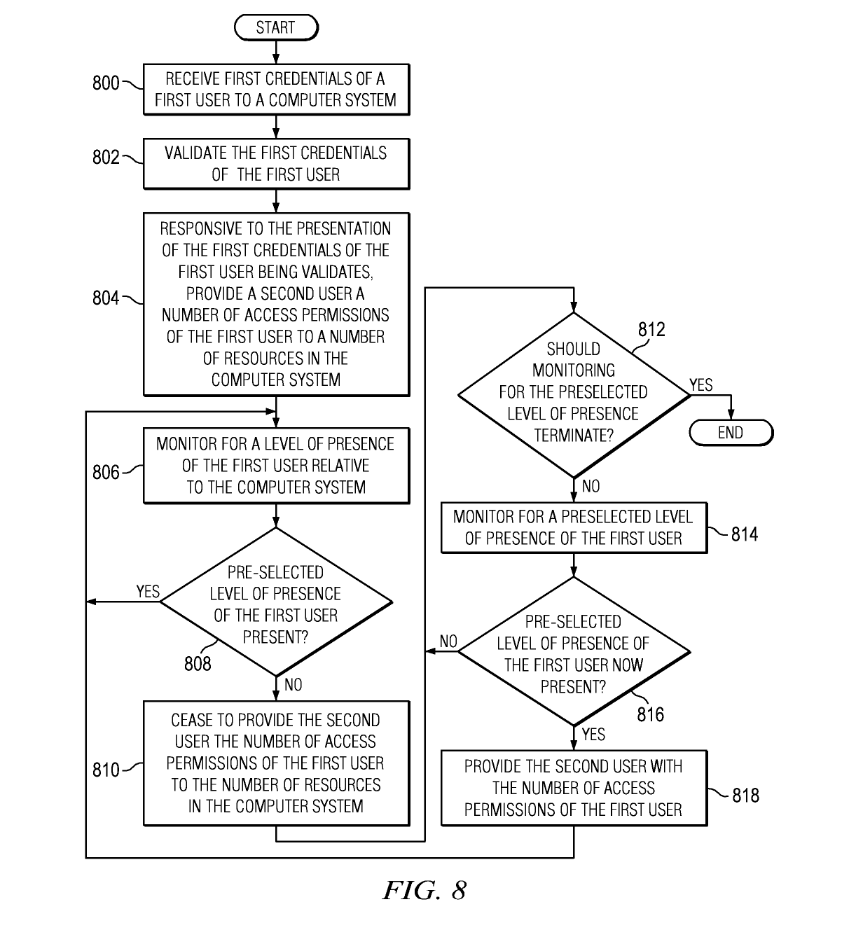

With reference now to FIG. 8, a flowchart of a process for managing resources in a network is depicted in accordance with an illustrative embodiment. The process in FIG. 8 may be implemented in resource management environment 300 in FIG. 3. In particular, these different steps may be steps performed by access control process 324. The different steps illustrated in this flowchart may be implemented in program code for running on one or more computers in computer system 302.

The process begins by receiving first credentials of a first user to a computer system (step 800). In this step, the first user presents the credentials. These credentials are used to determine whether to provide the user access to resources and what type of permissions are provided to the resources.

The process then validates the first credentials of the first user (step 802). The validation determines the identity of the first user and identifies the permissions that the first user has for access to different resources. In these illustrative examples, the first user is a trainer or supervisor.

Responsive to the first credentials for the first user being validated, a second user is provided a number of access permissions of the first user to a number of resources in the computer system (step 804). In these examples, the second user is a trainee.

Thereafter, the process monitors for a level of presence of the first user relative to the computer system (step 806). In these illustrative examples, the level of presence may take a number of different forms, such as described above. For example, the level of presence may be a physical presence of the first user at a computer, a number of actions performed by the first user, the type of actions performed by the first user, and other suitable factors that may be used to determine the level of presence of the first user.

A determination is made as to whether a preselected level of presence of the first user is present from the monitoring (step 808). If the preselected level of presence is present, the process returns to step 806. Otherwise, if the preselected level of presence is not present, the process ceases to provide the second user the number of access permissions of the first user to the number of resources in the computer system (step 810).

Next, a determination is made as to whether monitoring for the preselected level of presence should terminate (step 812). If the monitoring should terminate, the process terminates. The monitoring may terminate when the training session is completed, the first user has logged off, or some other suitable action. If monitoring of the preselected level of presence of the first user should not terminate, the process monitors for a preselected level of presence of the first user (step 814).

A determination is then made as to whether the preselected level of presence of the first user is now present (step 816). If the preselected level of the first user is present, the process then provides the second user with the number of access permissions of the first user (step 818), with the process returning to step 806 thereafter. In this manner, the number of permissions of the first user may be returned to the second user if the level of presence of the first user returns to the preselected level. Otherwise, the process returns to step 812 as described above.

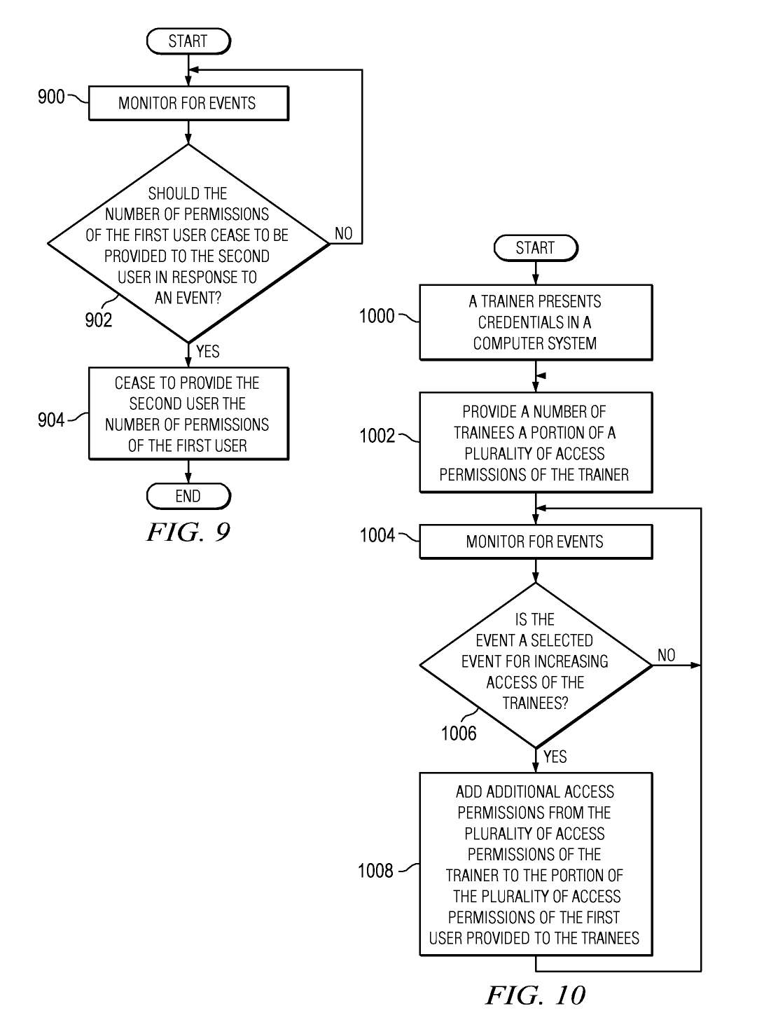

With reference now to FIG. 9, an illustration of a process for ceasing to provide a user permissions to access resources is depicted in accordance with an illustrative embodiment. The process illustrated in FIG. 9 may be implemented in resource management environment 300 in FIG. 3. In particular, the steps in this process may be implemented as program code that may be run by one or more computers for access control process 324 in FIG. 3.

The process begins by monitoring for events (step 900). These events may take a number of different forms. For example, the events may be actions by a user, a process, a change to a resource, or some other suitable event. A determination is made as to whether the number of permissions of the first user should cease to be provided to the second user in response to an event (step 902). This determination may be made using a policy, such as policy 500 in FIG. 5, in these examples.

If the number of permissions of the first user is no longer to be provided to the second user, the process ceases to provide the second user the number of permissions of the first user (step 904), with the process terminating thereafter. The second user is no longer provided the number of permissions of the first user even though a preselected level of presence of the first user is present in this example.

With reference again to step 902, if an absence of a determination is present to cease providing the second user the number of permissions of the first user occurs, the process returns to step 900 to continue to monitor for events.

With reference now to FIG. 10, a flowchart of a process for managing access to resources is depicted in accordance with an illustrative embodiment. The process illustrated in FIG. 10 may be implemented in resource management environment 300 in FIG. 3. In particular, these different steps may be implemented as part of access control process 324 in FIG. 3.

The process begins with a trainer presenting credentials in a computer system (step 1000). Thereafter, a number of trainees is provided a portion of a plurality of access permissions of the trainer (step 1002). The process then monitors for events (step 1004). In these examples, the events may be the completion of steps in the training session, a selected type of access to the resource, user input from the trainee, user input from the trainer, or other types of events.

A determination is made as to whether the event is a selected event for increasing access of the trainees (step 1006). Step 1006 may be performed using a policy, such as policy 500 in FIG. 5. If the event is not a selected event, the process returns to step 1004. Otherwise, the process adds additional access permissions from the plurality of access permissions of the trainer to the portion of the plurality of access permissions of the trainer provided to the trainees (step 1008). The process then returns to step 1004. In this manner, access permissions may be provided to trainees on a tiered or step basis.

Thus, the different illustrative embodiments provide a method and apparatus for managing resources. In response to the presentation of credentials of a first user to a computer system, a second user is provided a number of access permissions of the first user to a number of resources in the computer system. A level of presence of the first user relative to the computer system or to the second user is monitored. The second user continues to be provided the number of access permissions of the first user to the number of resources in the computer system as long as a preselected level of presence of the first user is present.

In this manner, access permissions of a first user may be provided to a second user based on a level of presence of the first user. As a result, a trainer does not need to log in at a computer with a trainee with the trainer's credentials. Instead, the trainee may log in and be provided access to additional permissions of the trainer on a temporary basis. In the illustrative embodiments, these additional permissions are provided as long as the trainer has a desired level of presence. In this manner, the trainer does not have to remember revoking access when the trainer ends the trainee session or recognizes that the trainer is not able to monitor the training session as desired. Further, the different illustrative embodiments provide a desired process from an auditing perspective, because users do not share identification cards or credentials.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, steps in two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any data processing system. For the purposes of this description, a computer-usable or computer readable medium can be any tangible apparatus that can contain, store, communicate, propagate, or transport the program for use by or in connection with the instruction data processing system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual running of the program code, bulk storage, and cache memories which provide temporary storage of at least some program code in order to reduce the number of times code must be retrieved from bulk storage during running of the program code by a processor unit.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing access to resources, the method comprising:
responsive to a presentation of first credentials for a first user to a computer system, providing, by the computer system, a second user a number of access permissions of the first user to a number of resources in the computer system;
monitoring, by the computer system, a level of presence of the first user relative to the computer system; and
continuing to provide, by the computer system, the second user the number of access permissions of the first user to the number of resources in the computer system as long as a preselected level of presence of the first user is present.

2. The method of claim 1 further comprising:
ceasing to provide the second user the number of access permissions of the first user to the number of resources in the computer system in response to an event using a policy even though the preselected level of presence of the first user is present.

3. The method of claim 1, wherein the level of presence is a collaboration proximity.

4. The method of claim 1, wherein the monitoring step comprises:
monitoring the level of presence of the first user relative to the computer system using a biometric sensor system.

5. The method of claim 1, wherein the number of access permissions of the first user is a portion of a plurality of access permissions of the first user and further comprising:
responsive to an event, adding additional access permissions from the plurality of access permissions of the first user to the number of access permissions of the first user provided to the second user.

6. The method of claim 5, wherein the event is a completion of a portion of a training session.

7. The method of claim 1, wherein the number of access permissions is a first number of access permissions and the number of resources is a first number of resources, and further comprising:
responsive to a presentation of second credentials for a third user to the computer system, providing the second user a second number of access permissions of the third user to a second number of resources in the computer system in addition to the first number of access permissions;
monitoring a level of presence of the third user relative to the computer system; and
continuing to provide the second user the second number of access permissions of the third user to the second number of resources in the computer system as long as a preselected level of presence of the third user is present.

8. The method of claim 1, wherein the number of resources is an application.

9. A data processing system comprising:
a bus;
a communications unit connected to the bus;
a storage device connected to the bus, wherein the storage device includes program code; and
a processor unit connected to the bus, wherein the processor unit runs the program code to provide a second user a number of access permissions of a first user to a number of resources in a computer system in response to a presentation of first credentials for the first user to the computer system; monitor a level of presence of the first user relative to the computer system; and continue to provide the second user the number of access permissions of the first user to the number of resources in the computer system as long as a preselected level of presence of the first user is present.

10. The data processing system of claim 10, wherein the processor unit further runs the program code to cease to provide the second user the number of access permissions of the first user to the number of resources in the computer system in response to an event using a policy even though the preselected level of presence of the first user is present.

11. A computer program product for managing access to resources, the computer program product comprising:
a computer recordable storage medium;
program code, stored on the computer recordable storage medium, for providing a second user a number of access permissions of the a user to a number of resources in the computer system in response to a presentation of first credentials for the first user to a computer system;
program code, stored on the computer recordable storage medium,
program code, stored on the computer recordable storage medium, for monitoring a level of presence of the first user relative to the computer system; and
program code, stored on the computer recordable storage medium, for continuing to provide the second user the number of access permissions of the first user to the number of resources in the computer system as long as a preselected level of presence of the first user is present.

12. The computer program product of claim 11 further comprising:
program code, stored on the computer recordable storage medium, for ceasing to provide the second user the number of access permissions of the first user to the number of resources in the computer system in response to an event using a policy even though the preselected level of presence of the first user is present.

13. The computer program product of claim 11, wherein the level of presence is a collaboration proximity.

14. The computer program product of claim 11, wherein the monitoring step comprises:
program code, stored on the computer recordable storage medium, for monitoring the level of presence of the first user relative to the computer system using a biometric sensor system.

15. The computer program product of claim 11, wherein the number of access permissions of the first user is a portion of a plurality of access permissions of the first user and further comprising:
program code, stored on the computer recordable storage medium, for adding additional access permissions from the plurality of access permissions of the first user to the number of access permissions of the first user provided to the second user in response to an event.

16. The computer program product of claim 15, wherein the event is a completion of a portion of a training session.

17. The computer program product of claim 11, wherein the number of access permissions is a first number of access permissions and the number of resources is a first number of resources, and further comprising:
program code, stored on the computer recordable storage medium, for providing the second user a second number of access permissions of a third user to a second number of resources in the computer system in addition to the first number of access permissions in response to a presentation of second credentials for the third user to the computer system;
program code, stored on the computer recordable storage medium, for monitoring a level of presence of the third user relative to the computer system; and
program code, stored on the computer recordable storage medium, for continuing to provide the second user the second number of access permissions of the third user to the second number of resources in the computer system as long as a preselected level of presence of the third user is present.

18. The computer program product of claim 11, wherein the number of resources is an application.

19. The computer program product of claim 11, wherein the program code is stored on the computer recordable storage medium in a data processing system, and wherein the program code is downloaded over a network from a remote data processing system to the data processing system.

20. The computer program product of claim 11, wherein the program code is stored on the computer recordable storage medium in a server data processing system, and wherein the program code is downloaded over a network to a remote data processing system for use in a second computer readable storage medium with the remote data processing system.
